(19) United States
(12) Patent Application Publication
(10) Pub. No.: US 2012/0185204 A1
(43) Pub. Date: Jul. 19, 2012

(54) METHOD FOR ESTIMATING THE DIRECTION OF A MOVING SOLID

(75) Inventors: Pierre Jallon, Grenoble (FR); Stéphane Bonnet, Lyon (FR)

(73) Assignees: Commissariat A L'Energie Atomique et aux Energies Alternatives, Paris (FR); Movea, Grenoble (FR)

(21) Appl. No.: 13/388,216

(22) PCT Filed: Jul. 26, 2010
(86) PCT No.: PCT/EP2010/060802

§ 371 Date: Apr. 9, 2012

(30) Foreign Application Priority Data
Jul. 31, 2009 (FR) 0955435

(51) Int. Cl. G06F 15/00

(52) U.S. Cl. 702/141

(57) ABSTRACT

The invention relates to a method for estimating the orientation in an inertial reference frame of a solid in motion equipped with an accelerometer and a magnetometer which are mounted on said solid.

According to this method, an orientation of the solid is measured at a reference instant, said orientation being defined by a rotation matrix for rotating from the mobile reference frame of the solid at the reference instant to the inertial reference frame. A rotation matrix for rotating between the orientation of the solid at a subsequent instant n and said orientation of the solid at the reference instant is thereafter estimated. The orientation of the solid at the instant n is thereafter determined with the aid of the previously estimated rotation matrix and of the known orientation of the solid at the reference instant.

### CROSS-REFERENCE TO RELATED APPLICATIONS

This application is a national phase application under 35 U.S.C §371 of PCT/EP2010/060802, filed Jul. 26, 2010, which claims priority to French Patent Application No. 0955435, filed Jul. 31, 2009, the entire contents of which are expressly incorporated herein by reference.

### BACKGROUND

1. Field of the Invention

The present invention pertains to the general field of estimation of the orientation and motion of a solid.

It relates to a method for estimating the orientation in an inertial reference frame of a solid in motion. It also pertains to a method for estimating the inherent acceleration of said solid.

2. Description of the Related Art

In a certain number of fields, it may be essential to determine the orientation and the motion of a solid in motion. Such is the case, for example, in robotics, teleoperations, and device calibrations, but also in the fields of multimedia and video games, as well as in the biomechanical and medical fields.

Thus, in the medical field, monitoring of a person can include, for example, in logging abnormal states which may signal an accident or a fit, such as a fainting fit or an epileptic fit.

Usually, motion of a body is determined by motion detectors comprising one or more sensors such as accelerometers, gyrometers and magnetometers, each with one to three sensitivity axes.

French patent FR 2 838 185 describes a method for determining the orientation of a sensor that may be placed on a solid. The orientation of the solid is estimated by so-called pitch, roll and yaw Euler angles, measured with the aid of an inertial fixed reference frame. It is natural to use a fixed reference frame comprising an axis directed toward the local magnetic North, an axis directed toward the local magnetic East and a third axis directed toward the ground. The sensor measures, at each instant, an acceleration vector and a magnetic field vector in a mobile reference frame of the sensor. The acceleration vector comprises a gravitational field component and a component of inherent acceleration of the solid. With the aid of the knowledge of the gravitational field component and of the magnetic field vector at a given instant, it is possible to determine the orientation of the solid at this instant. Indeed, the orientation of the solid may be defined by a matrix for the gravitational field and magnetic field vectors from the mobile reference frame of the solid to the inertial fixed reference frame. This conversion matrix can then be decomposed, in a known manner, into three elementary rotations of said Euler angles, said angles defining unambiguously the orientation of the solid in the inertial reference frame.

However, it is not generally possible to distinguish, under dynamic conditions, the contribution of the gravitational field component from that of the inherent acceleration in the acceleration vector measured by the accelerometer.

It is then necessary to supplement the accelerometer with additional sensors, such as gyrometers. However, the processing of the signal becomes particularly complex because signals from a plurality of sensors (accelerometers, gyrometers, magnetometers, etc.) have to be combined, the measurements from each sensor have specific uncertainties and some of them (for example, the gyrometers) have a temporal drift.

Another solution includes estimating the gravitational field component in the mobile reference frame of the solid at a given time, by an extrapolation of the acceleration vectors measured at the previous instants. The orientation of the solid at said given time is then determined with the aid of the measurement of the magnetic field vector at this time and of the extrapolation of the gravitational field vector at the same time. However, the uncertainty in the extrapolated gravitational field vector is all the more significant because it impacts the three spatial components of said vector. The calculated Euler angles are therefore significantly inaccurate.

### BRIEF DESCRIPTION

The main goal of embodiments of the invention is to disclose a method for estimating the orientation in an inertial reference frame of a solid in motion equipped with an accelerometer and a magnetometer which are mounted on said solid, at least partially remedying the above-mentioned drawbacks relating to the embodiments of the prior art.

Accordingly, the subject of embodiments of the invention is a method for estimating the orientation in an inertial reference frame of a solid in motion equipped with an accelerometer and a magnetometer which are mounted on said solid.

According to a preferred embodiment of the invention, the method comprises the steps of:
Measuring, at a reference instant n₀ for which the solid is devoid of inherent acceleration, gravitational field and magnetic field vectors in a reference frame of the solid, said measured vectors making it possible to determine an orientation of said solid in the inertial reference frame at the reference instant n₀;
Measuring, at various successive instants, acceleration vectors and magnetic field vectors in said reference frame of the solid;
Estimating a matrix U(n,n₀) making it possible to ensure the rotation of said orientation of the solid, previously determined at the reference instant n₀, to an orientation at a subsequent instant n,

said matrix U(n,n₀) being expressible in the form of a product of a first and of a second rotation matrix,

said first matrix being defined by a first angle of rotation of the magnetic field vector m(n₀) measured at the reference instant n₀ to the magnetic field vector m(n) measured at the instant n, about a first rotation vector oriented along the vector product of the magnetic field vectors measured at the instants n and n₀;

said second matrix being defined by a second angle of rotation about a second rotation vector chosen from among the magnetic field vectors measured at the instant n₀ and n, said second angle being estimated with the aid of the gravitational field vector a_{g}(n₀) measured at the reference instant n₀ and of a gravitational field vector extrapolated at the instant n â_{g}(n) with the aid of a plurality of acceleration vectors measured at instants prior to the instant n;
Estimating the orientation of the solid at the instant n with the aid of the matrix U(n,n₀) previously estimated and of said orientation at the reference instant n₀.

It should be noted that the gravitational field vector extrapolated at the instant n may be determined in the mobile reference frame of the solid.

Advantageously, the orientation of said solid in the inertial reference frame at an arbitrary instant k is defined by the conversion matrix R^{(k)} for passing from the reference frame of the solid at the instant k to the inertial reference frame, said orientation of the solid at the instant n being obtained through the relation R⁽ⁿ⁾=U(n,n₀)R⁽ⁿ^{₀}⁾.

Preferably, said first angle of rotation is estimated with the aid of the projection into an orthonormal basis of the magnetic field vectors measured at the instants n₀ and n, said basis being defined by first and second basis vectors oriented, respectively, along said first and second rotation vectors and by a third basis vector orthogonal to the first two.

According to a preferred embodiment of the invention, said second basis vector being the magnetic field vector measured at the instant n, said first angle of rotation is estimated through the relation: α(n,n₀)=arctan(m_{z}/m_{y}), where [0 m_{y} m_{z}] are the components of the projection in said basis of the magnetic field vector measured at the instant n₀.

According to a variant, said second basis vector being the magnetic field vector measured at the instant n₀, said first angle of rotation is estimated through the relation: α(n,n₀)=arctan(m_{z}/m_{y}), where [0 m_{y} m_{z}] are the components of the projection in said basis of the magnetic field vector measured at the instant n.

Alternatively, said first angle of rotation may be estimated through the scalar product of said magnetic field vector m(n₀) measured at the instant n₀ and of the magnetic field vector m(n) at the instant n, said vectors being previously normed.

Advantageously, said first angle of rotation being previously estimated, the second angle of rotation is estimated by comparison of the product of the matrix U(n,n₀) and of the gravitational field vector measured at the instant n₀ on the one hand, with said gravitational field vector extrapolated at the instant n on the other hand.

Alternatively, the second angle of rotation may be estimated through the scalar product of said gravitational field vector a_{g}(n₀) of gravitational field measured at the instant n₀ and of the gravitational field vector â_{g}(n₀) extrapolated at the instant n, said vectors being previously normed and projected into the plane orthogonal to said second rotation vector. The reference instant n₀ may be determined with the aid of measurements of the acceleration vectors.

Alternatively, the reference instant n₀ may be determined prior to the step of measuring the acceleration vectors.

The invention also relates to a method for estimating the inherent acceleration of a solid in motion equipped with an accelerometer and a magnetometer which are mounted on said solid, said method comprising the steps of:
Measuring, at a reference instant n₀ for which the solid is devoid of inherent acceleration, gravitational field and magnetic field vectors in a reference frame of the solid, said measured vectors making it possible to determine an orientation of said solid in the inertial reference frame at the reference instant n₀;
Measuring, at various successive instants, acceleration vectors ({a(k)}) and magnetic field vectors ({m(k)}) in said reference frame of the solid;
Estimating a matrix U(n,n₀) making it possible to ensure the rotation of said orientation of the solid, previously determined at the reference instant n₀, to an orientation at a subsequent instant n,

said matrix U(n,n₀) being expressible in the form of a product of a first and of a second rotation matrix,

said first matrix being defined by a first angle of rotation (α(n,n₀)) of the magnetic field vector m(n₀) measured at the reference instant n₀ to the magnetic field vector m(n) measured at the instant n, about a first rotation vector oriented along the vector product of the magnetic field vectors measured at the instants n and n₀ (m(n)×m(n₀));

said second matrix being defined by a second angle of rotation (θ(n,n₀)) about a second rotation vector chosen from among the magnetic field vectors measured at the instant n₀ and n, said second angle being estimated with the aid of the gravitational field vector a_{g}(n₀), measured at the reference instant n₀ and of a gravitational field vector extrapolated at the instant n (â_{g}(n)) with the aid of a plurality of acceleration vectors measured at instants prior to the instant n;
Estimating the orientation of the solid at the instant n with the aid of the matrix U(n,n₀) previously estimated and of said orientation at the reference instant n₀;
Calculating the gravitational field vector at the instant n as the product of the matrix U(n,n₀) estimated previously with the gravitational field vector measured at the reference instant n₀; and
Deducing the inherent acceleration vector of the solid at the instant n with the aid of the acceleration vector measured at the instant n and of the gravitational field vector at the instant n calculated previously.

Other advantages and characteristics of the invention will become apparent in the non-limiting detailed description hereinbelow.

### BRIEF DESCRIPTION OF THE DRAWINGS

Embodiments of the invention will now be described, by way of nonlimiting examples, while referring to the appended drawings, in which:

FIG. 1 is a schematic view of a solid in motion in an inertial reference frame;

FIG. 2 represents the gravitational field vector and magnetic field vector in the right-handed orthonormal basis B;

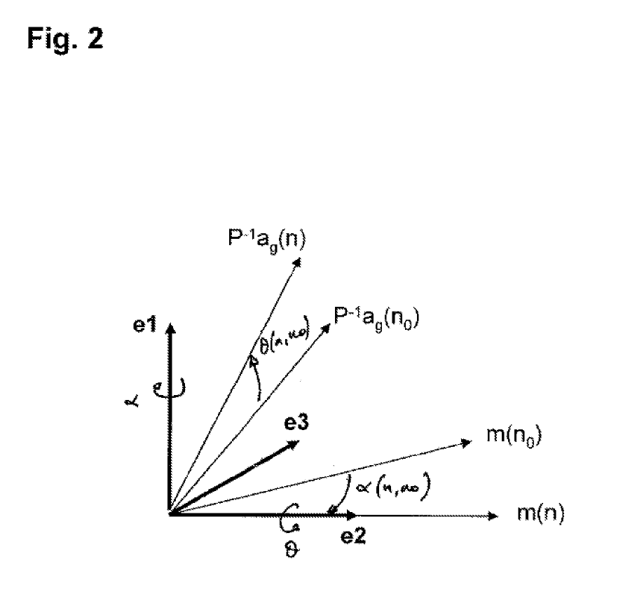

FIG. 3 represents a flowchart for implementing the method for estimating the orientation of the solid according to one embodiment of the invention; and

FIG. 4 represents a flowchart for implementing the method for estimating the inherent acceleration of the solid according to one embodiment of the invention.

### DETAILED DESCRIPTION OF THE PREFERRED EMBODIMENTS

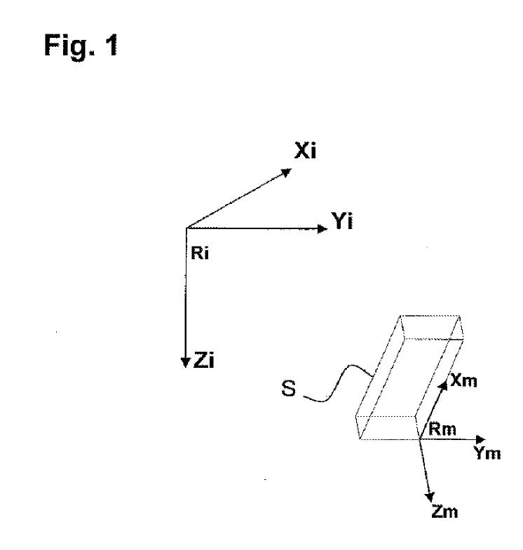

A solid S in motion in an inertial fixed reference frame Ri represented in FIG. 1 is considered. The inertial fixed reference frame Ri is defined by axes Xi, Yi, Zi directed respectively toward the local magnetic North, toward the local magnetic East and toward the ground. In this reference frame, also called NED (the acronym standing for North-East-Down), the terrestrial gravitational field and the terrestrial magnetic field may be written:

$$g = ‖ g ‖ ( \begin{matrix}0 \\ 0 \\ 1\end{matrix} ) and {m}_{T} = ‖ {m}_{T} ‖ ( \begin{matrix}cos κ \\ 0 \\ sin κ\end{matrix} ) \qquad$$

where the angle of inclination κ is about 60° in France.

The solid is equipped with an accelerometer and a magnetometer, both mounted solidly on said solid. Said accelerometer and said magnetometer each comprise three sensitivity axes, which, preferably, coincident and form a mobile reference frame Rm=(Xm,Ym,Zm) of the solid.

In the case where the axes of the accelerometer do not coincide with those of the magnetometer, it is assumed that at each instant an operation of conversion from the reference frame of the accelerometer to that of the magnetometer, or vice versa, is performed. The reference frame obtained then forms the reference frame of the solid. Hence, without loss of generality, it may be considered that the reference frame of the accelerometer and that of the magnetometer coincide with one another at each instant and form the reference frame of the solid.

The accelerometer provides, at successive instants k, the measurement of an acceleration vector in the mobile reference frame of the solid. The acceleration vector a(k) comprises a component of inherent acceleration of the solid aₚ(k) and a gravitational field component a_{g}(k).

The acceleration vectors measured by the accelerometer then form a set, denoted {a(k)}, of samples at successive instants k. Each sample a(k) therefore comprises three components along the inherent axes of the mobile reference frame of the solid.

In the particular case where the solid is in a static condition or in uniform rectilinear motion, the component of inherent acceleration of the solid is zero or negligible.

The magnetometer provides, preferably at the same instants k as the accelerometer, the measurement of a magnetic field vector in the mobile reference frame of the solid.

The magnetic field vectors measured by the magnetometer then form a set {m(k)} of samples at successive instants k. Each sample m(k) therefore comprises three components along the inherent axes of the mobile reference frame of the solid.

It should be noted that the measurement of the magnetometer may be independent of the inherent acceleration of the solid.

As explained previously, knowledge of the magnetic field vector m(n) and gravitational field vector a_{g}(n) at an arbitrary instant n amounts to determining the orientation of the solid in the inertial reference frame at the instant considered.

Indeed, at an arbitrary instant n, it is possible to write:

a_{g}(n)=R⁽ⁿ⁾g (1)

m(n)=R⁽ⁿ⁾m_{T} (2)

where R⁽ⁿ⁾ is the conversion matrix for switching from the mobile reference frame of the solid at the instant n to the inertial fixed reference frame.

This matrix R⁽ⁿ⁾ for converting from the reference frame of the solid at the instant n to the inertial reference frame can be expressed as a decomposition of three elementary rotations of Euler angles, such as those of pitch, roll, and yaw. Said Euler angles determine in a one-to-one manner the orientation of the solid in the inertial reference frame at the instant considered.

It should be noted that sole measurement of the magnetic field vector m(n) does not suffice to determine the conversion matrix R⁽ⁿ⁾. Indeed, when the magnetic field vector measured in the reference frame of the solid is collinear with the same vector expressed in the inertial reference frame, it forms an invariant axis about which the rotation by an arbitrary angle is not observable. This rotation leaving the magnetic field invariant can then be determined through the measurement of the gravitational field.

However, the accelerometer output information corresponds to the measurement of the acceleration vector which does not afford access directly to the gravitational field component and to the inherent acceleration component:

a(k)=a_{g}(k)+aₚ(k)=r^{(k)}g+aₚ(k) (3)

To have access to the gravitational field vector at the instant n, in the reference frame of the solid, it is possible to predict its value â_{g}(n) by extrapolation of the acceleration vectors {a(k)},k≦n measured at the instants earlier or equal to the instant n considered. This relies on the assumption, notably satisfied when the solid corresponds to a moving person, that the measurements of gravitational field and of inherent acceleration form, respectively, a low-frequency signal and a high-frequency signal. The extrapolation step may be performed by various known techniques, for example a linear polynomial type or a non-linear interpolation. Techniques of the Kalman-filter type can also be used.

According to various embodiments of the invention, and in contradistinction to the example of the prior art described previously, the orientation of the solid at an arbitrary instant n is not estimated directly with the aid of the projection in the inertial reference frame of the extrapolated gravitational field vector â_{g}(n) and measured magnetic field vector m(n).

Such an operation would in effect amount to determining the matrix \hat{R}⁽ⁿ⁾ defined by:

â_{g}(n)=\hat{R}⁽ⁿ⁾g

m(n)=\hat{R}⁽ⁿ⁾m_{T} (4)

where \hat{R}⁽ⁿ⁾ would comprise all the uncertainty of the extrapolated gravitational field vector â_{g}(n). Indeed, the uncertainty in the extrapolated vector â_{g}(n) is all the more significant as it comprises three degrees of freedom, namely the three spatial components of the vector â_{g}(n).

Conversely, the orientation of the solid at an instant n is determined with the aid of a known orientation of the solid at an earlier reference instant n₀ and through a rotation matrix U(n,n₀) making it possible to switch from the known orientation at the reference instant n₀ to the new orientation at the instant n. We thus write:

R⁽ⁿ⁾=U(n,n₀)R⁽ⁿ^{₀}⁾ (5)

Knowledge of the orientation of the solid at the reference instant n₀ corresponds to the determination of the conversion matrix R⁽ⁿ^{₀}⁾ through the magnetic field vectors m(n₀) and a_{g}(n₀) measured at the reference instant n₀.

Because the orientation of the solid at the instant n (resp. n₀) is defined by the magnetic field vector and gravitational field vector at the instant n (resp. n₀), relation (5) is equivalent to:

a_{g}(n)=U(n,n₀)a_{g}(n₀)

m(n)=U(n,n₀)m(n₀) (6)

Indeed, from relation (5), we obtain equation (6) which gives the magnetic field:

R⁽ⁿ⁾=U(n,n₀)R⁽ⁿ^{₀}⁾

[symbol]

R⁽ⁿ⁾m_{T}=U(n,n₀)R⁽ⁿ^{₀}⁾m_{T}

[symbol]

m(n)=U(n,n₀)m(n₀) (7)

It should be noted that, in the same manner as for the conversion matrix R⁽ⁿ⁾, knowledge of only the magnetic field vectors at the instants n₀ and n may not allow a determination of the matrix U(n,n₀). Indeed, when the magnetic field vectors at the instants n₀ and n are collinear to one another, they form an invariant axis about which a rotation of arbitrary angle may not be observed. This uncertainty may be resolved by knowing the gravitational field vectors at the instants n₀ and n.

The parameterization of the matrix U(n,n₀) is now described.

As stated previously, the measurements available at the instant n are the gravitational field vector a_{g}(n₀) and magnetic field vector m(n₀) measured at the reference instant n₀, the acceleration vector a(n) and magnetic field vector m(n) measured at the instant n, as well as a plurality of measurements at successive instants k preceding the instant n of acceleration vectors {a(k)},k<n and magnetic field vectors {m(k)},k<n. These vectors are measured in the mobile reference frame of the solid.

The parameterization of the matrix U(n,n₀) includes decomposing the rotation motion of the solid into a first elementary rotation defined by the switch from the magnetic field vector m(n₀) measured at the instant n₀ to the vector m(n) measured at the instant n, and then into a second elementary rotation about the magnetic field vector m(n) measured at the instant n. The matrix U(n,n₀) can therefore be decomposed into a first and a second rotation matrix describing, respectively, said first and said second elementary rotations.

Another possibility of matrix decomposition, equivalent to the previous, consists in writing a first matrix describing a first elementary rotation of the solid about the magnetic field vector at the instant n₀, and a second matrix describing a second elementary rotation of the solid and described by the switch from the magnetic field vector for the instant n₀ to the same vector at the instant n. This variant is described in detail further on.

According to the first possibility of decomposition of the matrix U(n,n₀), the first matrix describes the rotation of the magnetic field vector m(n₀) at the instant n₀ to the vector m(n) at the instant n. This first matrix is therefore defined by a first angle of rotation α(n,n₀) and by a first rotation vector oriented along, or collinear with, the vector product of these two magnetic field vectors m(n)×m(n₀).

The second matrix describes the rotation by a second angle of rotation θ(n,n₀) about a second rotation vector collinear with the magnetic field vector m(n) at the instant n.

It is then advantageous to parameterize said first and second matrices in a right-handed orthonormal basis constructed with the aid of said first and second rotation vectors.

Said orthonormal basis is denoted B=(e₁,e₂,e₃), where the first basis vector is collinear with said first rotation vector m(n)×m(n₀), the second basis vector e₂ is collinear with the second rotation vector m(n) and the third basis vector is orthogonal to the first two basis vectors eₗ and e₂.

The orthonormal basis B may be constructed in various ways, for example with the aid of a Gram-Schimdt scheme. Thus, if the scalar product of vectors x and y is denoted <x,y>, we construct:
the second basis vector e₂=m(n)/∥m(n)∥;
the third basis vector e₃=\tilde{e}₃/∥\tilde{e}₃∥, with \tilde{e}₃=m(n₀)−<m(n₀),e₂>e₂;
the first basis vector e₁=\tilde{e}₁/∥\tilde{e}₁∥, with \tilde{e}₁=m(n) [symbol] m(n₀)−<m(n) [symbol] m(n₀),e₂>e₂−<m(n) [symbol] m(n₀),e₃>e₃.

Thus, the basis vectors e₂ and e₃ span a plane which comprises the magnetic field vectors m(n), m(n₀) at the instants n and n₀, and the first basis vector eₗ is orthogonal to this plane.

Knowledge of only the magnetic field vectors at the instants n and n₀ suffices to construct the orthonormal basis B.

The matrix U(n,n₀) may be therefore written:

U(n,n₀)=P(n,n₀)·B_{θ}(n,n₀)·A_{α}(n,n₀)·P⁻¹(n,n₀) (8)

where P(n,n₀) is the conversion matrix for passing from the reference frame of the solid to the orthonormal basis B.

Said first matrix A_{α}(n,n₀) may be written, in this basis B:

$${A}_{α} ( n , {n}_{0} ) = [ \begin{matrix}1 & 0 & 0 \\ 0 & cos α ( n , {n}_{0} ) & sin α ( n , {n}_{0} ) \\ 0 & - sin α ( n , {n}_{0} ) & cos α ( n , {n}_{0} )\end{matrix} ] \qquad ( 9 )$$

The first angle of rotation α(n,n₀) may be determined with the aid of the components of the magnetic field vectors m(n), m(n₀) at the instants n and n₀. By definition of the angle α(n,n₀), we can write:

P⁻¹(n,n₀)·m(n)=A_{α}(n,n₀)·P⁻¹(n,n₀)·m(n₀) (10)

Moreover, the magnetic field vectors at the instants n and n₀ in the orthonormal basis B may be written, respectively:

$$\begin{matrix}{P}^{- 1} ( n , {n}_{0} ) \cdot m ( n ) = ‖ m ( n ) ‖ ( \begin{matrix}0 \\ 1 \\ 0\end{matrix} ) & ( 11 ) \\ {P}^{- 1} ( n , {n}_{0} ) \cdot m ( {n}_{0} ) = ‖ m ( {n}_{0} ) ‖ ( \begin{matrix}0 \\ {m}_{Y} ( {n}_{0} ) \\ {m}_{Z} ( {n}_{0} )\end{matrix} ) & ( 12 )\end{matrix}$$

Noting that the matrix A_{α}(n,n₀) is orthogonal and has determinant 1, the inverse of the matrix is the transpose of the latter. Relation (10) can be written:

P⁻¹(n,n₀)·m(n₀)=^{t}A_{α}(n,n₀)·P⁻¹(n,n₀)·m(n) (13)

which, with relations (11) and (12), becomes:

$$‖ m ( {n}_{0} ) ‖ ( \begin{matrix}0 \\ {m}_{Y} ( {n}_{0} ) \\ {m}_{Z} ( {n}_{0} )\end{matrix} ) = ( \begin{matrix}0 \\ cos α ( n , {n}_{0} ) \\ sin α ( n , {n}_{0} )\end{matrix} ) \qquad ( 14 )$$

The first angle of rotation is then determined by the relation:

a(n,n₀)=arctan(m_{Z}(n₀)/m_{Y}(n₀)) (15)

Alternatively, it is also possible to determine a(n,n₀) through the scalar product of said magnetic field vectors at the instants n and n₀, previously normed.

The first matrix A_{α}(n,n₀) is therefore fully determined with the aid of the components of the magnetic field vectors m(n₀) and m(n) measured at the instants n₀ and n.

The second matrix B_{θ}(n,n₀) may be written in this basis B:

$${B}_{θ} ( n , {n}_{0} ) = [ \begin{matrix}cos θ ( n , {n}_{0} ) & 0 & sin θ ( n , {n}_{0} ) \\ 0 & 1 & 0 \\ - sin θ ( n , {n}_{0} ) & 0 & cos θ ( n , {n}_{0} )\end{matrix} ] \qquad ( 16 )$$

The rotation described by the second matrix B_{θ}(n,n₀) takes place about the second basis vector e₂, the latter being collinear with the magnetic field vector m(n) measured at the instant n. It is therefore not accessible to the measurements of the magnetic field vectors at the instants n₀ and n.

The second angle of rotation θ(n,n₀) can however be estimated with the aid of the gravitational field vector measured at the instant n₀, and of an extrapolation â_{g}(n) of the gravitational field vector at the instant n, in the reference frame of the solid, with the aid of the acceleration vectors {a(k)},k≦n. This extrapolation may be performed by known techniques, such as those described previously.

The determination of the second angle of rotation θ(n,n₀) may be performed through the scalar product of the gravitational field vector a_{g}(n₀) measured at the reference instant n₀ and of the gravitational field vector â_{g}(n) extrapolated at the instant n, said vectors being previously normed and projected onto the plane orthogonal to said second rotation vector. This step is then independent of the step of determining the first angle of rotation α(n,n₀).

Another way of determining the second angle of rotation θ(n,n₀) may be through the use of a least squares, or similar, scheme for example:

θ(n,n₀)=min_{θ}∥U(n,n₀)a_{g}(n₀)−â_{g}(n)∥² (17)

It should be noted that this step of determining θ(n,n₀) by optimization may be advantageously performed after determining the first angle of rotation α(n,n₀). Thus, the optimization scheme pertains to only one unknown, the angle θ(n,n₀), and not to two unknowns θ(n,n₀) and α(n,n₀).

Thus, the second matrix B_{θ}(n,n₀) is fully determined with the aid of the components of the magnetic field vectors m(n₀) and m(n) measured at the instants n₀ and n, as well as by the components of the gravitational field vector measured at the instant n₀ and by those of the same vector â_{g}(n) extrapolated at the instant n.

In a particularly advantageous manner, the uncertainty at the instant n no longer exhibits three degrees of freedom each pertaining to the three spatial components of the vector â_{g}(n), but a single degree of freedom pertaining to the second angle of rotation θ(n,n₀).

The parameterization of the first and second rotation matrices then makes it possible to accurately estimate the rotation matrix U(n,n₀).

The determination of the orientation of the solid at the instant n, defined by the conversion matrix R⁽ⁿ⁾, can therefore be obtained through the product of the rotation matrix U(n,n₀) and of the orientation of the solid at the reference instant n₀, defined by)R⁽ⁿ^{₀}⁾. The conversion matrix R⁽ⁿ⁾ thus determined comprises greater accuracy than the conversion matrix \hat{R}⁽ⁿ⁾ mentioned previously, insofar as the number of degrees of freedom of the uncertainty has been reduced.

The alternative parameterization of the rotation matrix U(n,n₀) mentioned previously is now described.

It includes decomposing the rotation motion of the solid into a first rotation about the magnetic field vector m(n₀) at the instant n₀, and then into a second rotation of the magnetic field vector m(n₀) at the instant n₀ to the same vector m(n) at the instant n.

The matrix U(n,n₀) is then similar to that described previously. However, the second rotation vector of the second matrix is collinear with the magnetic field vector m(n₀) at the instant n₀. The orthonormal basis may therefore be constructed in the following manner:
the second basis vector e₂=m(n₀)/∥m(n₀∥;
the third basis vector e₃=\tilde{e}₃/∥\tilde{e}₃∥, with \tilde{e}₃=m(n)−<m(n),e₂>e₂;
the first basis vector e₁=\tilde{e}₁/∥\tilde{e}₁∥, with \tilde{e}₁=m(n) [symbol] m(n₀)−<m(n) [symbol] m(n₀),e_{2>e}₂−<m(n) [symbol] m(n₀),e_{3>e}₃.

The matrix U(n,n₀) may therefore be written:

U(n,n₀)=P(n,n₀)·Aₐ(n,n₀)·B_{θ}(n,n₀)·P⁻¹(n,n₀) (18)

The determination of the first angle of rotation α(n,n₀) may be similar to that described previously, except that we obtain the relation:

α(n,n₀)=arctan(m_{Z}(n)/m_{Y}(n)) (19)

where [0 m_{y} m_{z}] are the components of the projection in said basis of the magnetic field vector m(n) measured at the instant n.

The determination of the second angle of rotation θ(n,n₀) may be identical or similar to that described previously.

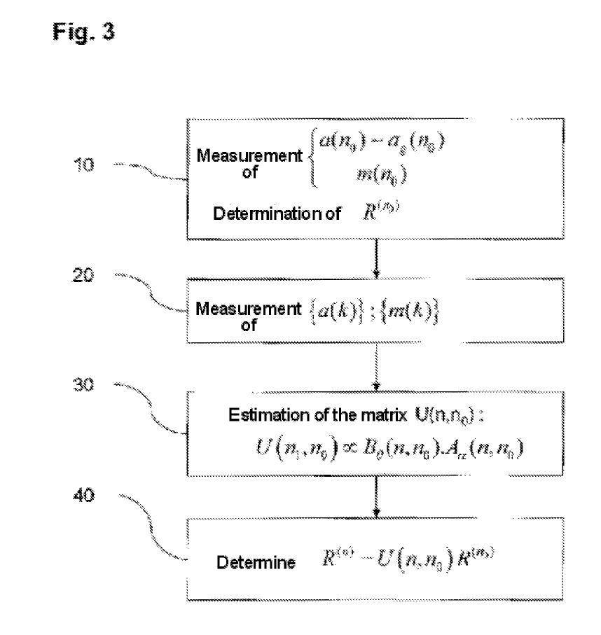

A method for estimating the orientation of the solid at an instant n in the inertial reference frame is now described with reference to FIG. 3.

In step 10, the acceleration vector and magnetic field vector are measured at the reference instant n₀ for which the solid is devoid of inherent acceleration. The measured acceleration vector then comprises only its gravitational field component. From this is deduced the orientation of the solid at the reference instant n₀ through the conversion matrix R⁽ⁿ^{₀}⁾ for passing from the reference frame of the solid at the reference instant n₀ to the inertial reference frame.

In the following step 20, acceleration vectors {a(k)} and magnetic field vectors {m(k)} are measured at various successive instants.

In step 30, the rotation matrix U(n,n₀) for rotating from the orientation of the solid at the reference instant n₀ to the orientation of the solid at a subsequent instant n is estimated.

The orthonormal basis B=(e₁,e₂,e₃) such as defined previously is constructed.

The first rotation matrix is parameterized with the aid of the magnetic field vectors measured at the instants n₀ and n.

The second rotation matrix is parameterized with the aid of the magnetic field vector measured at the instant n₀ and of the same vector extrapolated at the instant n.

The estimation of the rotation matrix U(n,n₀) is thus obtained.

In the final step 40, the orientation of the solid at the instant n is deduced through the product of the rotation matrix U(n,n₀) and of the conversion matrix R⁽ⁿ^{₀}^{) at the reference instant n}₀.

As a variant of step 10, and as explained previously, the gravitational field vector a_{g}(n₀) at the reference instant n₀ may be chosen with the aid of measurements obtained in step 20, notably by calculating the variance of the acceleration vectors measured during a defined time window.

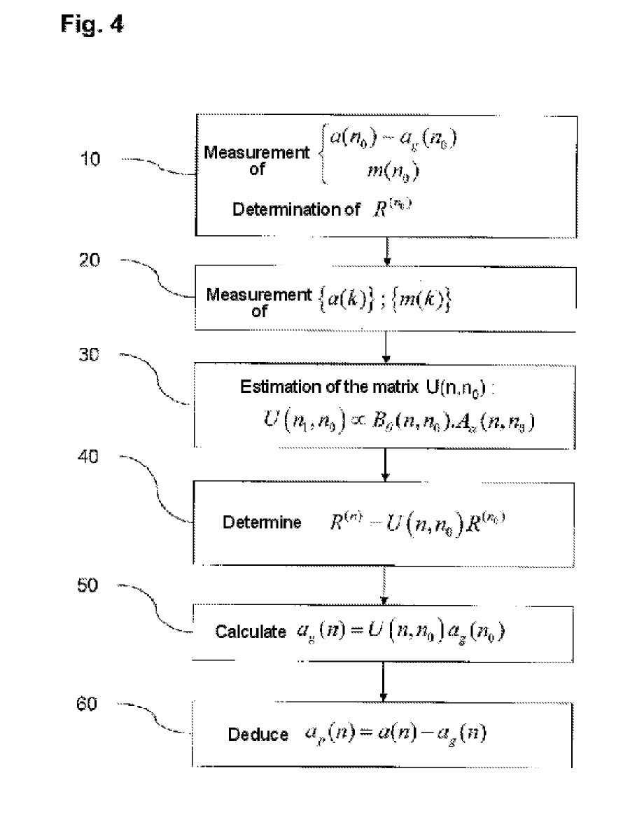

A method for estimating the inherent acceleration of the solid at an instant n in the mobile reference frame of the solid is now described with reference to FIG. 4.

The method for estimating the orientation of the solid at the instant n such as described previously is implemented.

In step 50, the gravitational field vector at the instant n may thereafter be calculated with the aid of the product of the matrix U(n,n₀) previously estimated with the gravitational field vector measured at the instant n₀:

a_{g}(n)=U(n,n₀)a_{g}(n₀) (20)

This vector demonstrates greater accuracy than that of the same vector extrapolated at the instant n with the aid of the acceleration vectors measured at the earlier instants, for the same reason as previously, namely that the number of degrees of freedom of the uncertainty has been reduced from three degrees to a single degree during the estimation of the rotation matrix U(n,n₀).

Lastly, in the final step 60, the inherent acceleration vector of the solid at the instant n is deduced by differencing the acceleration vector measured at the instant n and the gravitational field vector at the instant n calculated previously:

aₚ(n)=a(n)−a_{g}(n) (21)

The inherent acceleration vector of the solid is thus determined at the instant n. The orientation and the motion of the solid are thus accurately known.

1. A method for estimating orientation in an inertial reference frame of a solid in motion equipped with an accelerometer and a magnetometer which are coupled to said solid, said method comprising the steps of:
measuring, at a reference instant n₀ for which the solid is devoid of inherent acceleration, gravitational field and magnetic field vectors in a reference frame of the solid, said measured vectors usable to determine an orientation of said solid in the inertial reference frame at the reference instant n₀;
measuring, at successive instants, acceleration vectors ({a(k)}) and magnetic field vectors ({m(k)}) in said reference frame of the solid;
estimating a matrix U(n,n₀) usable to ensure rotation of said orientation of the solid, previously determined at the reference instant n₀, to an orientation at a subsequent instant n,
said matrix U(n,n₀) being expressible in the form of a product of a first and of a second rotation matrix,
said first matrix being defined by a first angle of rotation α(n,n₀) of the magnetic field vector m(n₀) measured at the reference instant n₀ to the magnetic field vector m(n) measured at the instant n, about a first rotation vector oriented along a vector product of the magnetic field vectors measured at the instants n and n₀;
said second matrix being defined by a second angle of rotation θ(n,n₀) about a second rotation vector chosen from among the magnetic field vectors measured at the instant n₀and n, said second angle being estimated using the gravitational field vector a_{g}(n₀), measured at the reference instant n₀ and of a gravitational field vector extrapolated at the instant n (â_{g}(n)) using a plurality of acceleration vectors measured at instants prior to the instant n;
estimating the orientation of the solid at the instant n using the matrix U(n,n₀) previously estimated and of said orientation at the reference instant n₀.

2. The method of claim 1, wherein the orientation of said solid in the inertial reference frame at an arbitrary instant k is defined by a conversion matrix R^{(k)} for passing from the reference frame of the solid at the instant k to the inertial reference frame, said orientation of the solid at the instant n being obtained through the relation R⁽ⁿ⁾=U(n,n₀)R⁽ⁿ^{₀}⁾.

3. The method of claim 1, wherein said first angle of rotation α(n,n₀) is estimated using a projection into an orthonormal basis of the magnetic field vectors measured at the instants n₀ and n, said basis being defined by first and second basis vectors oriented, respectively, along said first and second rotation vectors and by a third basis vector orthogonal to the first two.)

4. The method of claim 3, wherein, said second basis vector is the magnetic field vector measured at the instant n, said first angle of rotation is estimated through a relation: α(n,n₀)=arctan(m_{z}/m_{y}), where [0 m_{y} m_{z}] are components of a projection in said basis of the magnetic field vector measured at the instant n₀.

5. The method of claim 3, wherein, said second basis vector is the magnetic field vector measured at the instant n₀, said first angle of rotation is estimated through the relation: α(n,n₀)=arctan(m_{z}/m_{y}), where [0 m_{y} m_{z}] are components of a projection in said basis of the magnetic field vector measured at the instant n.

6. The method of claim 1, wherein said first angle of rotation α(n,n₀) is estimated through a scalar product of said magnetic field vector m(n₀) measured at the instant n₀ and magnetic field vector m(n) measured at the instant n, said vectors being previously normed.

7. The method of claim 1, wherein, said first angle of rotation α(n,n₀) being previously estimated, the second angle of rotation θ(n,n₀) is estimated by comparison of a product of the matrix U(n,n₀) and of the gravitational field vector measured at the instant n₀ with said gravitational field vector extrapolated at the instant n.

8. The method of claim 1, wherein the second angle of rotation θ(n,n₀) is estimated using a scalar product of said gravitational field vector a_{g}(n₀) measured at the instant n₀ and of the gravitational field vector â_{g}(n) extrapolated at the instant n, said vectors being previously normed and projected into a plane orthogonal to said second rotation vector.

9. The method of claim 1, wherein the reference instant n₀ is determined using measurements of the acceleration vectors.

10. The method of claim 1, wherein the reference instant n₀ is determined prior to the step of measuring the acceleration vectors.

11. A method for estimating inherent acceleration of a solid in motion equipped with an accelerometer and a magnetometer which are coupled to said solid, said method comprising the steps of:
measuring, at a reference instant n₀ for which the solid is devoid of inherent acceleration, gravitational field and magnetic field vectors in a reference frame of the solid, said measured vectors usable to determine an orientation of said solid in the inertial reference frame at the reference instant n₀;
measuring, at successive instants, acceleration vectors ({a(k)}) and magnetic field vectors ({m(k)}) in said reference frame of the solid;
estimating a matrix U(n,n₀) usable to ensure rotation of said orientation of the solid, previously determined at the reference instant n₀, to an orientation at a subsequent instant n,
said matrix U(n,n₀) being expressible as a product of a first and of a second rotation matrix,
said first matrix being defined by a first angle of rotation α(n,n₀) of the magnetic field vector m(n₀) measured at the reference instant n₀ to the magnetic field vector m(n) measured at the instant n, about a first rotation vector oriented along a vector product of the magnetic field vectors measured at the instants n and n₀;
said second matrix being defined by a second angle of rotation θ(n,n₀) about a second rotation vector chosen from among the magnetic field vectors measured at the instant n₀ and n, said second angle being estimated using the gravitational field vector a_{g}(n₀), measured at the reference instant n₀ and of a gravitational field vector extrapolated at the instant n (â_{g}(n)) using a plurality of acceleration vectors measured at instants prior to the instant n;
estimating the orientation of the solid at the instant n using the matrix U(n,n₀) previously estimated and of said orientation at the reference instant n₀;
calculating the gravitational field vector at the instant n (a_{g}(n)) as a product of the matrix U(n,n₀) estimated previously with the gravitational field vector measured at the reference instant n₀ (a_{g}(n₀));
deducing an inherent acceleration vector of the solid at the instant n using the acceleration vector measured at the instant n and of the gravitational field vector at the instant n calculated previously.
